(19) United States
(12) Patent Application Publication
(10) Pub. No.: US 2018/0008909 A1
(43) Pub. Date: Jan. 11, 2018

(54) Degasification apparatus

(71) Applicant: Thomas Barkel, Ypsilanti, MI (US)

(72) Inventor: Thomas Barkel, Ypsilanti, MI (US)

(21) Appl. No.: 15/202,517

(22) Filed: Jul. 5, 2016

(51) Int. Cl. B01D 19/00

(52) U.S. Cl. CPC B01D 19/0042; B01D 19/0005; B01D 19/0063

(57) ABSTRACT

The present disclosure relates to a degasification apparatus having means to contact and interact with liquid flow, degas liquid, reduce or eliminate turbulent flow, and in most cases increase liquid flow rate.

### FIELD

The present disclosure generally relates to a degasification apparatus. More particularly, the present disclosure relates to a degasification apparatus having means to contact and interact with liquid flow, degas liquid, reduce or eliminate turbulent flow, and in most cases increase liquid flow rate.

### BACKGROUND

This section provides background information related to the present disclosure which is not necessarily prior art.

Current methods used for degassing liquid are not practical or efficient. One such method is commonly known as freeze-pump-thaw cycling. Freeze-pump-thaw cycling is generally performed by applying a substantial amount of liquid nitrogen to liquid being held within a container, with the liquid subsequently becoming frozen. Next, said container is sealed and a vacuum is applied to pump the frozen liquid. Subsequently, warm water is applied to the frozen liquid in order to thaw the liquid, and upon thawing, gas bubbles form and escape from the liquid. This cycle of freezing, pumping, and thawing typically occurs two more times in order to attain adequate degasification of liquid. Said cycle is not efficient or effective in most situations for many reasons of which generally include degassing of liquid not being completed in an efficient manner, cycle not being effective when applied to a moving and/or flowing liquid, and said cycle is not compatible with most potables due to the substantial risk of each stage of the cycle causing an undesired alteration of taste or composition of potable. Additionally, the freeze-pump-thaw cycle may break or cause malfunction of container, typically during freezing stage. Furthermore, the cost of equipment and long periods of time required to complete the freeze-pump-thaw cycle is substantially high which creates additional inefficiencies and ineffectiveness.

Given the above problems, it is now an objective of the present disclosure to provide a degasification apparatus that is compatible with liquid flow and most containers, is low cost, and efficiently and effectively degasses liquid, reduces or eliminates turbulent flow, and increases liquid flow rate.

### SUMMARY

This section provides a general summary of the disclosure, and is not a comprehensive disclosure of its full scope or all of its features.

Degasification apparatus embodiments of present disclosure generally comprise means to contact and interact with liquid flow, degas liquid, reduce or eliminate turbulent flow of liquid, and in most cases increase liquid flow rate.

Degasification apparatus embodiments of present disclosure are typically securely positioned in the route or path of liquid flow. When properly secured, degasification apparatus embodiments of present disclosure are typically immovable but removable. Typically, degasification apparatus embodiments of present disclosure are positioned within a liquid conduit.

Degasification apparatus embodiments of present disclosure seek to be compatible with any and all liquid flows.

Degasification apparatus embodiments of present disclosure seek to be compatible with both potable and non-potable liquids.

Degasification apparatus embodiments of present disclosure are generally constructed with means to be low cost and efficient.

### BRIEF DESCRIPTION OF THE DRAWINGS

The drawings described herein are for illustrative purposes only of selected embodiments and not all possible implementations, and are not intended to limit the scope of the present disclosure.

FIG. 1 is a perspective sectional view of liquid conduit with first degasification apparatus embodiment removably secured to inner surface.

FIG. 2 is a schematic perspective sectional view of liquid conduit with surface angle and degasification apparatus embodiment of FIG. 1 with liquid flow lines indicating the manner in which surface angle and degasification apparatus embodiment interact with liquid flow.

FIG. 3 is a perspective sectional view of a variation of degasification apparatus embodiment of FIG. 1 with four semi-circular flow conveyors affixed within liquid conduit.

FIG. 4 is a schematic perspective sectional view of liquid conduit with another degasification apparatus embodiment with liquid flow lines indicating the manner in which this degasification apparatus embodiment interacts with liquid flow.

FIG. 5 is a close-up perspective view of a variation of deviator of FIG. 4.

FIG. 6 is a close-up perspective view of another variation of deviator of FIG. 4.

FIG. 7 is a close-up perspective sectional view of liquid conduit, with another deviator embodiment variation.

FIG. 8 is a perspective sectional view of liquid conduit with another degasification apparatus embodiment.

FIG. 9 is a perspective view of a variation of degasification apparatus embodiment of FIG. 8.

FIG. 10 is a perspective view of another variation of degasification apparatus embodiment of FIG. 8.

FIG. 11 is a perspective view of another variation of degasification apparatus embodiment of FIG. 8.

FIG. 12 is a perspective view of another variation of degasification apparatus embodiment of FIG. 8.

FIG. 13 is a sectional view of a liquid conduit containing two triangular flow conveyors and flow director.

FIG. 14 is a sectional view of a liquid conduit containing one circular flow conveyor and flow director.

FIG. 15 is a sectional view of a liquid conduit containing seven circular flow conveyors and a flow director.

FIG. 16 is a sectional view of a liquid conduit containing two semi-circular flow conveyors and a flow director.

FIG. 17 is a sectional view of a liquid conduit containing six semi-circular flow conveyors and a flow director.

FIG. 18 is a sectional view of a liquid conduit containing one square flow conveyor, eight semi-circular flow conveyors, and a flow director.

Corresponding reference numerals indicate corresponding parts throughout the several views of the drawings.

### DETAILED DESCRIPTION

Example embodiments will now be described more fully with reference to the accompanying drawings.

Degasification apparatus embodiments of present disclosure are typically removably secured and activated in the route or path of liquid flow, typically within liquid conduit 29. Degasification apparatus embodiments generally comprise means to degas liquid, reduce or eliminate turbulent flow of liquid, and in most cases, increase liquid flow rate. Furthermore, Degasification apparatus embodiments generally comprise means to be compatible with any and all liquid flows, and contact liquid. Degasification apparatus embodiments can be utilized for potable or non-potable liquids. Degasification apparatus embodiments typically contact and interact with liquid flow with means to degas liquid and/or reduce turbulent flow, with said liquid flow continuing downstream after contacting and interacting with degasification apparatus embodiment. Additionally or alternatively, the functionalities and/or components of degasification apparatus embodiments may be in various combinations of sorts, an example of said combinations may generally include a degasification apparatus embodiment comprising means to degas liquid but not comprising means to reduce turbulent flow or increase liquid flow rate. Additionally or alternatively, degasification apparatus embodiments may not be positioned and/or secured within liquid conduit 29 or path of liquid flow.

Degasification apparatus embodiments of present disclosure are typically secured to other surfaces and/or liquid conduit 29 via adjoining with a separate interlocking mechanism positioned within liquid conduit 29 but may additionally or alternatively be secured via welding technique, integration, connection, flange, junction, thread, fastening, snap-fit, quick-release, uniform arrangement, adjoining, or adhesive.

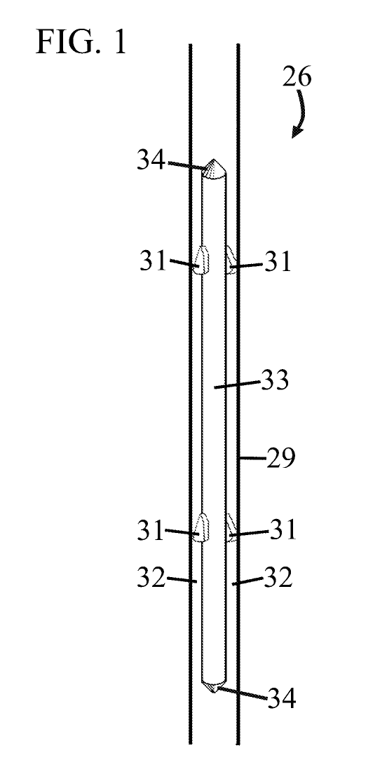

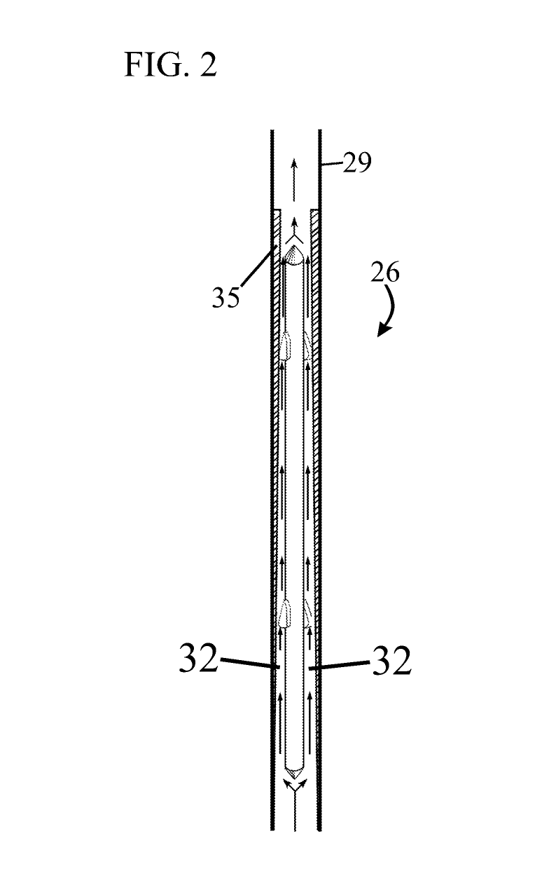

Additionally or alternatively, degasification apparatus embodiments may be constructed to snap or grip on to another surface, subsequently becoming secured due to frictional forces acting between the degasification apparatus embodiment and other surface, as shown in FIG. 1 and FIG. 2.

When properly secured, degasification apparatus embodiments of present disclosure are typically immovable but removable; removal of degasification apparatus embodiments is typically accomplished via physically deactivating the mechanism, device, method, or technique used to achieve its secured positioning, typically, with degasification apparatus embodiment subsequently being removed from path of liquid flow. A liquid flow path and/or liquid conduit 29 may include multiple degasification apparatus embodiments. Degasification apparatus embodiments may be secured by interlocking with a separate mechanism or device. Degasification apparatus embodiments are typically constructed with means to be compatible with and secured in any conduit.

Degasification apparatus embodiments and/or related components may be in combination with one another or in a varying assortment. Degasification apparatus embodiments typically comprise mostly plastic but may additionally or alternatively be made of metal, plastic and metal, paper based, entirely plastic, rubber, otherwise firm material, or a combination of sorts. Degasification apparatus embodiments are typically made of plastic primarily with means to be less expensive and have less weight.

Liquid conduit 29 generally comprises a conduit or hollow cylinder and means for conveying liquid flow. Liquid conduit 29 typically comprises one conduit but may additionally or alternatively comprise at least two conduits. Degasification apparatus embodiments of present disclosure are typically secured to inner surface of liquid conduit 29 but may additionally or alternatively be positioned and secured to other surfaces and/or other components.

Degasification apparatus embodiments of present disclosure may generally provide degasification of liquid by interacting with and/or contacting liquid in one, or more than one, various ways as such but not limited to, reducing cross-sectional area of liquid flow, reducing cross-sectional area of liquid conduit 29, reducing partial pressure, reducing turbulent flow, aeration, stirring, mixing, gas transfer, constriction, and/or swirling.

Degasification apparatus embodiments comprising means to accomplish degasification via stirring, mixing, and/or swirling typically provide said degasification via liquid flow contacting and/or interacting with said degasification apparatus embodiment with liquid then embodying a swirling, stirring, and/or mixing movement, typically with gas of liquid becoming physically released, replaced, and/or reduced, thus resulting in reduced or eliminated gas levels in the liquid.

Degasification apparatus embodiments of present disclosure comprise means to degas liquid, typically with gas being carbon dioxide, and as such upon degasification occurring the liquid loses some or all of its gas composition, carbonation, and/or carbon dioxide.

Degasification apparatus embodiments may be generally constructed with components positioned in a sequential manner downstream generally as such with means to contact and interact with liquid flow multiple times as the liquid moves downstream. Furthermore, said components are typically aligned and/or parallel with one another but may additionally or alternatively not be parallel and/or aligned with one another. Said degasification apparatus embodiment typically comprises symmetrical components, but may additionally or alternatively comprise components that are asymmetrical. Typically, liquid contacts each surface of said degasification apparatus as such causing degasification via gas being physically released from liquid, aeration, and/or gas composition of liquid to be replaced with air, thus resulting in reduced or eliminated gas levels of liquid.

Turbulent flow may also be referred to as turbulence. Turbulent flow is generally defined as liquid flow that has a chaotic flow regime, eddies, and lateral mixing. Turbulence can cause an increase in the gas level of liquid; an example of this can be generally demonstrated by the act of shaking a bottle of champagne which subsequently causes the champagne to have increased turbulence and an increased gas level with substantial amounts of carbonation and/or agitation.

Degasification apparatus embodiments of present disclosure generally provide a reduction or elimination of turbulent flow via contacting and interacting with liquid in one, or more than one, various ways, as such but not limited to, establishing a more orderly flow regime, reducing lateral mixing, high momentum diffusion, and/or decreasing liquid flow momentum.

Said reduction of lateral mixing is typically accomplished via degasification apparatus embodiments reducing lateral movement of liquid flow as liquid flow moves downstream, typically by providing a more controlled channel for liquid flow, reducing cross-sectional area of liquid flow, and/or temporarily decelerating movement of liquid flow.

With general reference to FIGS. 1 through 3 an exemplary embodiment of a degasification apparatus in accordance with the present disclosure is illustrated and generally identified at reference character 26. Degasification apparatus embodiment 26 typically generally comprises flow conveyors 32, flow director 33, and flow bracers 31. Flow conveyors 32, flow director 33, and flow bracers 31, herein collectively referred to as liquid flow apparatus 30. Liquid flow apparatus 30 is typically over 0.4 inch (1.016 cm) in total length but can increasingly or decreasingly vary in size. Flow director 33 typically directs liquid flow into flow conveyors 32. Flow bracers 31 are typically streamlined and positioned near the center of liquid flow with means to reduce or eliminate turbulence.

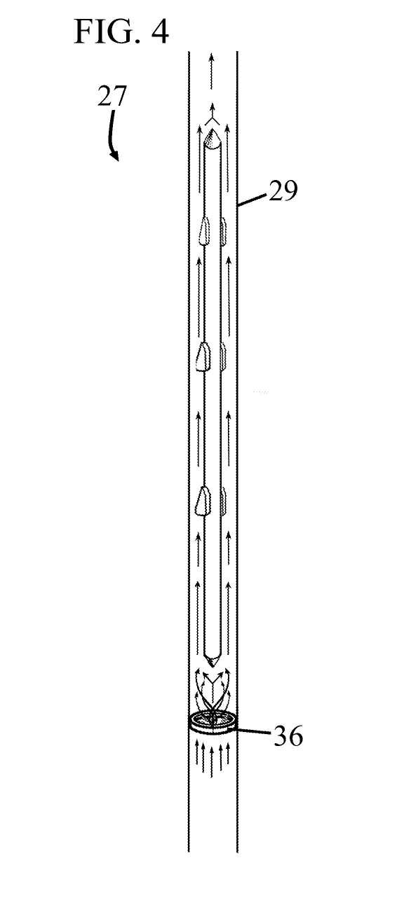

Turning to FIGS. 4 through 7, another exemplary embodiment of a degasification apparatus is shown and generally identified at reference character 27. Degasification apparatus 27 differs from degasification apparatus 26 primarily in that it comprises deviator 36. The components of deviator 36 typically generally include a perimeter body, deviator openings 37, and deviator surface area 38. Deviator 36 is typically positioned within liquid conduit 29. Deviator 36 typically generally comprises means to degas liquid. Given the similarities between the two embodiments, like reference characters will be used to identify similar features.

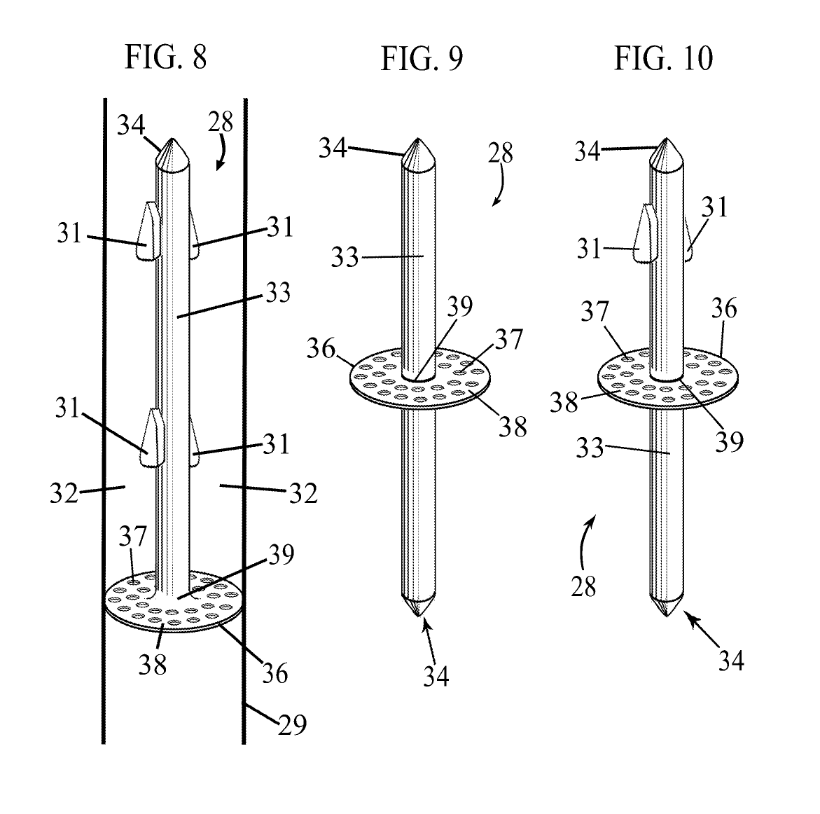

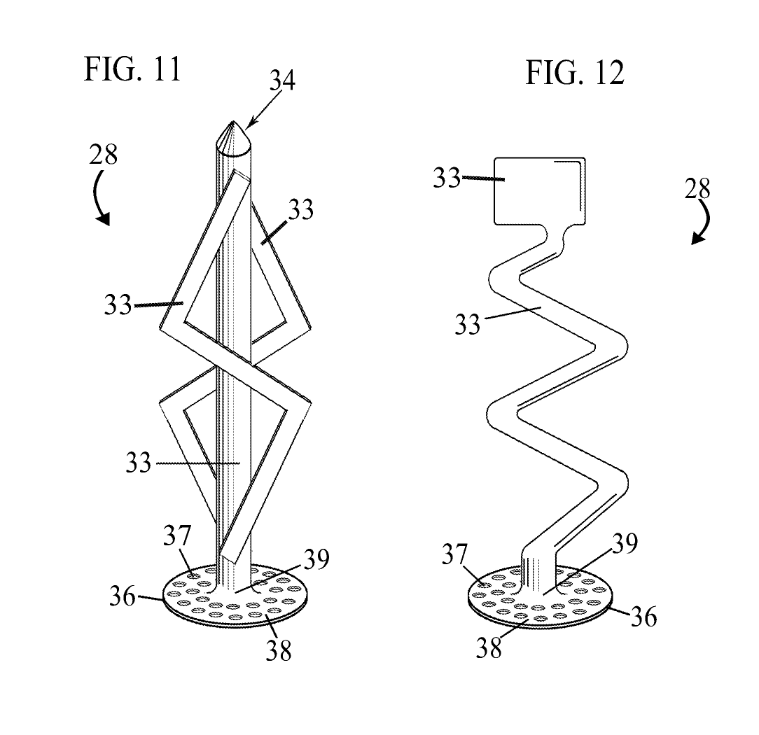

Turning to FIGS. 8 through 12, another exemplary embodiment of a degasification apparatus is shown and generally identified at reference character 28. Degasification apparatus 28 differs from degasification apparatus 26 and 27 primarily in that it comprises liquid flow apparatus 30 and deviator 36 being adjoined, integrated, or connected to one another. Given the similarities between the embodiments, like reference characters will be used to identify similar features.

Flow conveyor 32 generally comprises conduit for conveying liquid flow. Flow conveyor 32 is typically in numbers of at least two. Flow conveyors 32 typically provide a reduction in cross-sectional area of liquid flow and convey liquid flow, as shown in FIG. 2. Liquid flow is generally defined as liquid that is moving. Flow conveyors 32 generally comprise means to provide a reduction in turbulent flow, and in most cases, increase liquid flow rate, furthermore, flow conveyors 32 may additionally or alternatively reduce or eliminate gas level of liquid. Flow conveyors 32 may reduce the gas level of liquid via reducing turbulent flow and/or temporarily extending the amount of time that liquid is exposed to air as it moves through flow conveyors 32 thus resulting in air replacing and/or removing the gas composition of the liquid. Flow conveyors 32 typically reduce turbulent flow by creating a more orderly liquid flow regime. This orderly flow regime is generally created via the inner surfaces of each flow conveyor 32 increasing the available surface area upon which viscous forces acting between the liquid and the surfaces can form, thereby reducing these viscous forces and reducing or eliminating turbulent flow. Flow conveyors 32 are typically in numbers of at least two but flow conveyors 32 may alternatively be singular.

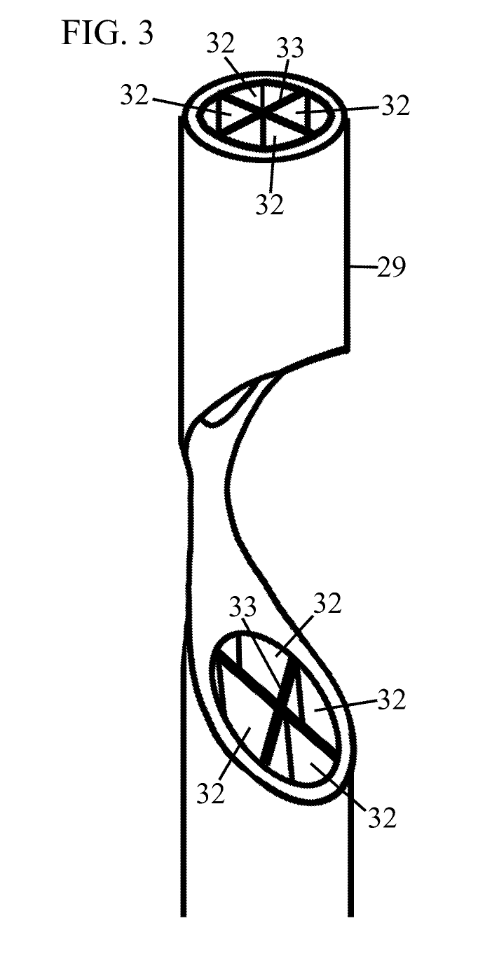

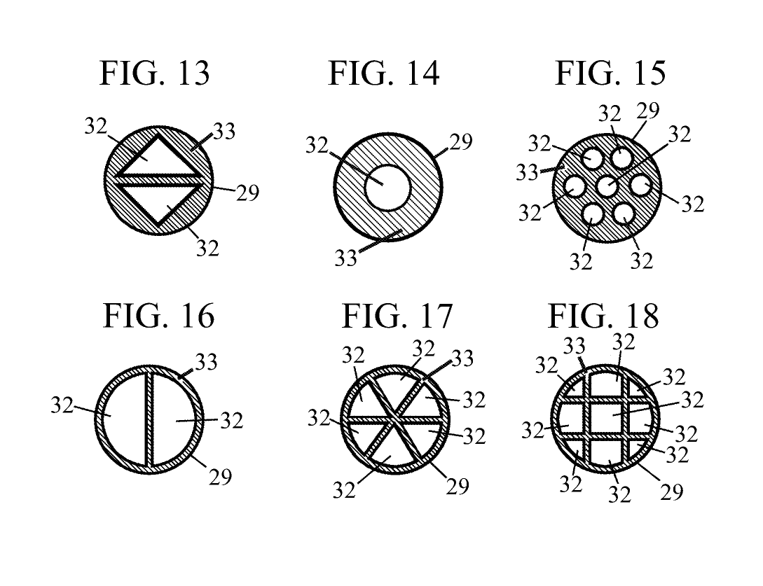

Flow director 33 typically comprises a cylindrically shaped body centrally positioned within the route or path of liquid flow, and is typically generally aligned parallel with the direction of liquid flow. Flow director 33 is typically constructed with rounded, pointed, or otherwise angled ends 34 as such with means to minimize creation of turbulence when liquid flow contacts flow director 33 and/or when flow director 33 directs liquid flow. Flow director 33 can vary in shape, configuration, size, components, or dimensions. Embodiment 26 typically comprises at least one flow director 33, but may additionally or alternatively comprise at least two flow directors 33. Flow director 33 may additionally or alternatively be constructed to resemble the appearance of surface and/or wall, typically subdividing liquid conduit 29 and forming flow conveyors 32, as shown in FIG. 3, and FIGS. 13 through 18.

Typically, flow director 33 is supported by flow bracers 31. Flow bracers 31 are typically connected to flow director 33 between outer portion of flow director 33 and inner surface of liquid conduit 29. Flow bracers 31 are of adequate strength to hold flow director 33 in its secured position, even in the presence of liquid flow, as such with primary means to prevent flow director 33 from becoming undesirably dislodged or moved. Flow bracers 31 may additionally or alternatively be separate from flow director 33 and integrated or connected to another surface as such with means to receive flow director 33 and become interlocked with one another. An example of said interlocking may generally include flow bracers 31 being connected with inner surface of liquid conduit 29 and flow director 33 being inserted into liquid conduit 29 and subsequently interlocking with said flow bracers 31. Said interlocking may be utilized by any and all components of degasification apparatus embodiments as such with components being the same as components previously mentioned, having an addition or reduction of said components, having an addition or reduction of other components, or a combination of sorts.

Flow bracers 31 generally comprise means to be streamlined, minimize their disturbance of liquid flow, and deter, reduce, and/or eliminate turbulent flow. Flow bracers 31 are typically positioned near the center of liquid flow as such with means to maximize reduction or elimination of turbulent flow due to the typical characteristics of turbulent flow having increased turbulence towards the center of the flow. Flow bracers 31 typically minimize the turbulence they may cause upon contacting liquid flow as such by being generally constructed with a semi-monocoque or otherwise airfoil shape. An example of said construction may generally include flow bracer 31 having a rounded end facing upstream and extending to a tapered end facing downstream. Additionally or alternatively, flow bracers 31 may comprise means to hold another component and/or not hold flow director 33. Additionally or alternatively, flow bracers 31 may not be in connection with flow director 33, said flow bracers 31 may generally connect with one, or more than one, surfaces within liquid conduit 29 and/or secure to another component or surface.

Flow bracers 31 are typically in numbers of at least one. In the case of a degasification apparatus embodiment that contains flow director 33, flow director 33 may not require flow bracers 31 to keep flow director 33 secure as it may be securely affixed directly to inner surfaces of liquid conduit 29 forming the flow conveyors 32 and subdividing the liquid conduit 29 as shown in FIG. 3.

Additionally, optionally, or alternatively, degasification apparatus embodiments may comprise surface angle 35. Surface angle 35 is typically in connection with inner surface of liquid conduit 29 and provides a gradual decrease of cross-sectional area of liquid flow, additionally or alternatively, surface angle 35 may provide a gradual increase of cross-sectional area of liquid flow. Surface angle 35 varies in size but is typically over 1 inch (2.54 cm) in length. Surface angle 35 is envisaged to decrease overall turbulence and agitation of liquid flow, turbulence and agitation that may otherwise increase gas level of liquid. Surface angle 35 is constructed with means to alter cross-sectional area of liquid flow while simultaneously avoiding a large angle alteration which may result in increased turbulence as liquid flow is forced to alter its cross-sectional area over a short distance. Therefore, surface angle 35 is typically constructed with an angle comprising between five and twenty degrees but may increasingly or decreasingly vary in degree. Liquid conduit 29 may comprise its cross-sectional area increasing in size, decreasing in size, or a combination of sorts in addition to, or in lieu of, surface angle 35. Surface angle 35 is typically constructed to provide a symmetrical cross-sectional area alteration of liquid conduit 29 as such being in connection with all inner surfaces of liquid conduit 29, additionally or alternatively, surface angle 35 may provide an alteration that is not symmetrical and/or be connected with other surfaces, or a combination of sorts. Additionally or alternatively, surface angle 35 may include more than one angle, and/or be integrated or affixed to liquid conduit 29.

Degasification apparatus embodiments typically increase liquid flow rate. This increase in liquid flow rate is generally determined by calculating the liquid flow rate prior to degasification apparatus embodiments being securely positioned and activated, and comparing it with the liquid flow rate after degasification apparatus embodiments are securely positioned and activated. Degasification apparatus embodiments generally provide an increase in liquid flow rate via utilizing principles of fluid mechanics. One such principle is commonly known as the Venturi Effect. The Venturi Effect generally states that a reduction in fluid pressure can be caused by a constriction in tubing and simultaneously create an increase in fluid velocity. This reduction in fluid pressure typically causes an increase in liquid flow rate upon liquid flow moving through and past the constriction. Additionally or alternatively, constriction of liquid flow may degas said liquid; this can be generally caused by said constriction applying a temporary deceleration of liquid flow during its movement downstream and thus exposing the liquid to atmospheric pressure for an extended duration, this extended exposure to atmospheric pressure typically degases liquid via reducing the partial pressure of the liquid and/or replacing the gas composition of liquid with air, thus makes the gas less compatible and/or soluble with the liquid, this degasification of liquid typically occurs when liquid is moving within an environment that is closed, liquid conduit 29, and/or not exposed to an adequate amount atmospheric pressure to cause degasification without said temporary deceleration. Another principle that gives present disclosure the capability to increase liquid flow rate is commonly referred to as Bernoulli's Principle. Bernoulli's Principle can be derived from Newton's 2nd law and generally states that when a small volume of liquid is flowing from a region of high pressure to a region of low pressure, then there is more pressure behind than in front, which accelerates the flow. An exemplary demonstration of the Venturi Effect and Bernoulli's Principle being applied in present disclosure may generally include flow conveyors 32 constricting liquid flow, and said liquid flow moving at a greater speed upon moving through and past said conveyors 32.

Degasification apparatus embodiments of present disclosure typically increase liquid flow rate in one, or more than one, ways, as such but not limited to, reducing cross-sectional area of liquid flow, reducing cross-sectional area of liquid conduit 29, utilizing the Bernoulli's Principle, and/or utilizing the Venturi Effect.

As shown in FIG. 4 degasification apparatus embodiment 27 comprises deviator 36. Embodiment 27 typically doesn't include liquid flow apparatus 30. Additionally or alternatively, liquid flow apparatus 30 may be generally positioned upstream from deviator 36, downstream from deviator 36, both upstream and downstream from deviator 36, or a combination of sorts. Deviator 36 typically includes deviator surface area 38 and deviator openings 37. Deviator openings 37 are typically in numbers of more than one but may additionally or alternatively be singular. Embodiment 27 typically comprises one deviator 36, but may alternatively comprise more than one deviator 36. Deviator surface area 38 is typically constructed to reduce the cross-sectional area of liquid conduit 29 and/or liquid flow. Deviator surface area 38 generally comprises means to contact and interact with liquid flow, degas liquid, and direct liquid flow through deviator openings 37. Deviator 36 is typically securely positioned and activated within liquid conduit 29 as such being immovable but removable with its perimeter body being flush to inner surface of liquid conduit 29 and without negatively affecting functionality of liquid conduit 29. When deviator 36 comprises means to be securely positioned and activated within liquid conduit 29, deviator 36 is generally constructed to comply with dimensions, size, cross-sectional area, and/or shaping of liquid conduit 29 as such with means to effectively utilize its functionalities within liquid conduit 29, avoid interfering with liquid conduit 29 functionalities, and be immovable but removable, upon being securely positioned and activated.

Deviator 36 generally comprises means to degas liquid, and typically alters movement of liquid flow during and after liquid flow contacts and interacts with deviator 36. Deviator 36 may generally provide degasification of liquid and/or alteration of liquid flow movement through utilization of one, or more than one, various actions, as such but not limited to, stirring, aeration, gas transfer, swirling, mixing, cascading, and/or decanting. An example of deviator 36 degassing and altering movement of liquid flow is demonstrated in FIG. 4, with deviator 36 causing liquid flow to adopt a generally intersecting movement downstream after contacting, interacting with, and moving through deviator 36 with means to provide degasification of liquid by gas transfer, mixing, and/or stirring liquid flow, typically as such via physically releasing gas from liquid and/or mixing air with liquid during its intersecting movement downstream. Another example may generally include deviator 36 causing liquid flow to have a movement downstream that is generally stable after liquid flow contacts, interacts with, and moves through deviator 36 as such with said deviator 36 comprising means to degas liquid primarily via aeration and gas transfer. The actions of deviator 36 may vary and are primarily dependent on the composition, sizing, dimensions, components, and shaping of deviator 36 and/or its components.

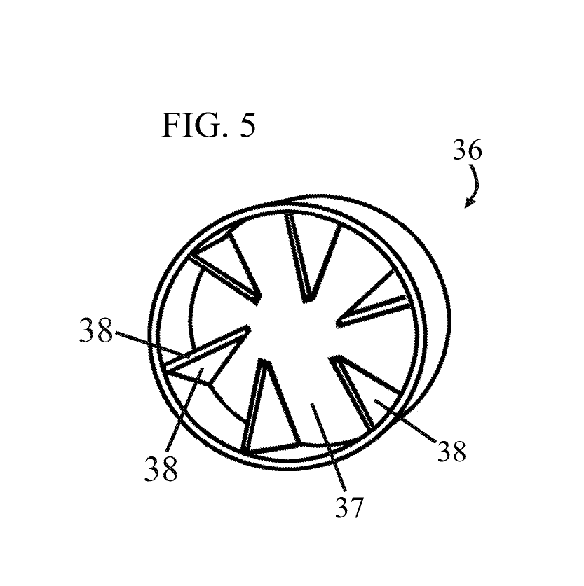

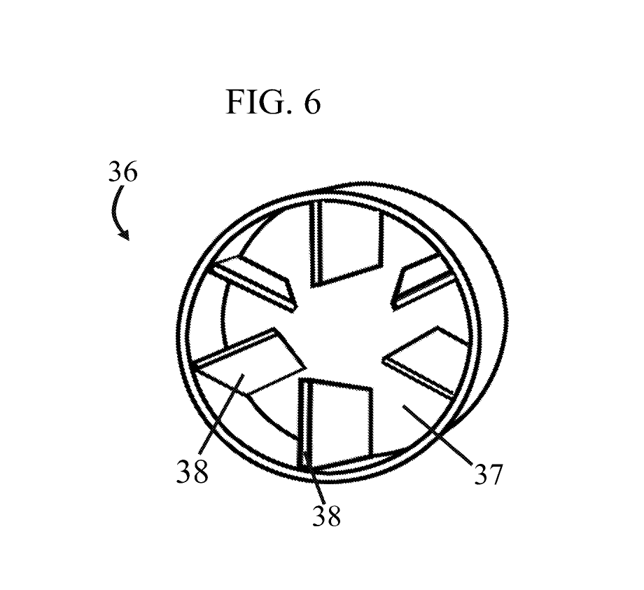

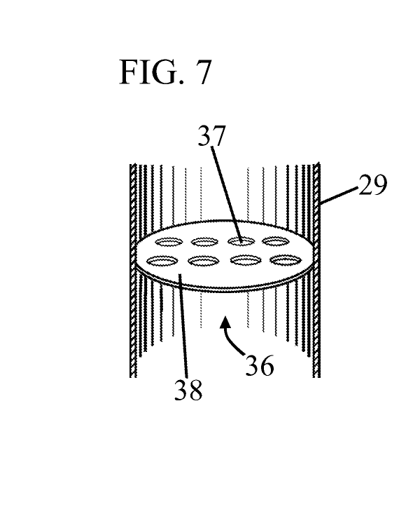

Deviator 36 typically comprises one, or more than one, surface area 38 inwardly extending from perimeter body towards cross-sectional area of liquid conduit 29 with openings 37 perforating deviator surface area 38 as shown in FIG. 7, alternatively or additionally, deviator 36 may comprise one, or more than one, surface areas 38 inwardly extending towards cross-sectional area of liquid conduit 29 with deviator openings 37 being adjacent to said surface area 38 as shown in FIG. 5 and FIG. 6, and/or comprise deviator openings 37 that are adjacent to and perforating surface area 38. Deviator 36 typically degasses liquid via utilizing aeration. Aeration is generally defined as the process by which air is mixed with, circulated through, or dissolved in a liquid as such applying a gas transfer generally resulting in air replacing or reducing the gas content of the liquid. Aeration generally occurs upon liquid flow contacting deviator surface area 38 and being directed through deviator openings 37, more specifically, with the deviator surface area 38 being proportional with drop or bubble size, the very surface area 38 where gas transfer can occur, utilizing small bubbles or drops increases the rate of aeration due to a higher amount of contact surface area 38 and smaller amount of deviator openings 37, thus conversely when deviator 36 comprises a lower amount of contact surface area 38 and higher amount of deviator openings 37 rate of aeration is decreased. Additionally or alternatively, aeration may be generally achieved via liquid flow moving through flow conveyors 32 generally due to flow conveyors 32 increasing the amount of air that the liquid is exposed to during its temporary deceleration as it moves through flow conveyors 32.

In liquid conduit 29 that comprises both deviator 36 and liquid flow apparatus 30, liquid flow typically generally contacts, interacts with, and moves through deviator 36, subsequently moving downstream and contacting, interacting with, and moving through liquid flow apparatus 30, as shown in FIG. 4. Liquid flow may become turbulent as it moves downstream after contacting and interacting with deviator 36. Liquid flow apparatus 30 typically comprises means to reduce or eliminate turbulent flow of liquid flow that may or may not be caused by deviator 36 as such via liquid flow apparatus 30 being upstream and/or downstream from deviator 36. Liquid flow apparatus 30 and/or its components generally reduce or eliminate turbulent flow via diffusing the momentum of liquid flow, applying a more orderly flow regime, reducing the viscous forces of liquid flow, and/or applying low momentum convection. Components of liquid flow apparatus 30 and/or deviator 36 may decrease and/or increase in quantity.

Degasification apparatus embodiment 28 generally comprises liquid flow apparatus 30 and deviator 36. In embodiment 28 liquid flow apparatus 30 and deviator 36 are connected, integrated, or adjoined one another, as shown in FIG. 8. Embodiment 28 is typically constructed with liquid flow apparatus 30 being downstream from deviator 36, alternatively or additionally, liquid flow apparatus 30 may be upstream from deviator 36, upstream and downstream from deviator 36, or a combination of sorts. The location of connection between liquid flow apparatus 30 and deviator 36 varies but is typically at the deviator surface area 38 and is represented by character reference 39. Embodiment 28 typically generally comprises means for liquid flow apparatus 30 to provide an increased effectiveness of reducing or eliminating turbulent flow that may be caused by deviator 36. Said increased effectiveness is envisaged to be provided as such via liquid flow apparatus 30 being in closer proximity to deviator 36 and thus allowing liquid flow apparatus 30 to reduce or eliminate turbulent flow as it moves downstream more effectively than if the proximity was larger, before, during, and/or after it contacts and interacts with deviator 36. Components of embodiment 28 may increasingly and/or decreasingly vary in number, as demonstrated in FIG. 9 with flow bracers 31 of liquid flow apparatus 30 not being present. Furthermore, said components may vary in shape, configuration, components, dimensions, size, and form as demonstrated in FIGS. 8 through 12.

Degasification apparatus embodiments and/or components of degasification apparatus embodiments may additionally or alternatively be removable and/or adjustable, either partially or wholly, as such with means to typically generally be repositioned, resized, detached, fixed, removed, reconfigured, cleaned, and/or deactivated.

Additionally, optionally, or alternatively, components of liquid flow apparatus 30 and deviator 36 may comprise variations in shape, quantity, dimensions, components, form, characteristics, size, or composition. Exemplary demonstrations of said variations may generally include liquid flow apparatus 30 components adopting the same form and/or functionality as components of deviator 36, such as flow conveyors 32 of FIG. 17 becoming deviator openings 37, and flow director 33 of FIG. 17 becoming deviator surface area 38.

Additionally, alternatively, or optionally, present disclosure may generally include a mechanism or device generally comprising means for adjusting position of a degasification apparatus embodiment, said mechanism or device herein referred to as repositioner. Repositioner typically adjusts the position of degasification apparatus embodiments along a vertical axis but may additionally or alternatively adjust the position of degasification apparatus embodiments along a rotational and/or horizontal axis, or a combination of sorts. Repositioner typically adjusts one degasification apparatus embodiment but may additionally or alternatively adjust more than one degasification apparatus embodiment. Repositioner typically adjusts the position of degasification apparatus embodiment via force being applied to repositioner with degasification apparatus embodiment subsequently moving into different position and/or force being applied to degasification apparatus embodiment and repositioner subsequently allowing movement of degasification apparatus embodiment. Typically, repositioner includes mechanism for locking and unlocking movement of degasification apparatus embodiment typically as such via operator physically interacting with mechanism to unlock and lock movement of degasification apparatus embodiment. Repositioner is typically separate in relation to degasification apparatus embodiments but may additionally or alternatively be integrated, adjoined, or connected to degasification apparatus embodiments. An exemplary usage of repositioner may generally include repositioner having a rectangular surface connected to inner surface of liquid conduit 29 and comprising vertical parallel grooves aligned with degasification apparatus embodiment, two threaded bars connected with body of degasification apparatus embodiment and outwardly extending with each bar's distal end secured within parallel grooves of repositioner, and a threaded nut on each of the bars as such when said nuts are tightened degasification apparatus embodiment is locked into position within the parallel grooves and when nuts are loosened degasification apparatus embodiment can be repositioned along the territory of the vertical parallel grooves. Repositioner generally comprises components for adjusting position of degasification apparatus embodiment and/or locking or unlocking movement of degasification apparatus embodiment, as such but not limited to, groove, interlocking slot, quick release, collapsible parts, roller, adjustable components, sliding arrangement, counter-sunk slot, interlocking mechanism, and/or adjustable mechanism or device. Additionally or alternatively, components of degasification apparatus embodiments may comprise repositioner functionalities as such primarily comprising means to adjust the position, size, form, function, or configuration of said degasification apparatus embodiments.

Additionally, alternatively, or optionally, present disclosure may generally include a mechanism or device comprising means to deactivate degasification apparatus embodiments. This mechanism or device typically deactivates degasification apparatus embodiments, either wholly or partially, while degasification apparatus embodiments are securely positioned, within liquid conduit 29, and/or path of liquid flow. This mechanism or device typically generally deactivates degasification apparatus in a toggle manner as such with ability to deactivate and also reactivate degasification apparatus. Additionally or alternatively, deactivation may occur when degasification apparatus embodiments are not securely positioned, within liquid conduit 29, and/or path of liquid flow. Said mechanism or device generally provides deactivation by preventing degasification apparatus embodiments from utilizing one, some, or all of its functionalities. Said functionalities typically generally include reducing or eliminating gas level of liquid, reducing or eliminating turbulent flow, increasing liquid flow rate, interacting with liquid, and/or contacting liquid. An example of said deactivation may generally include this mechanism or device detaching and removing the deviator 36 of embodiment 28 from liquid conduit 29 as such preventing embodiment 28 from contacting or degassing liquid via deviator 36. Said mechanism or device is typically separate in relation to degasification apparatus embodiments but may additionally or alternatively be adjacent, connected, integrated, or adjoined to degasification apparatus embodiments. Said mechanism or device typically deactivates one degasification apparatus embodiment but may additionally or alternatively deactivate more than one degasification apparatus embodiment.

It will now be appreciated that the present teachings provide a degasification apparatus which is low cost and comprises means to degas liquid, reduce or eliminate turbulent flow of liquid, and in most cases increase liquid flow rate, in an efficient and effective manner.

The foregoing description of the embodiment(s) has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure. One or more example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

1. Liquid conduit comprising: a body resembling a hollow cylinder and means to convey liquid; a degasification apparatus immovably but removably secured within path of liquid flow and comprising one cylindrically shaped flow director, at least two streamlined flow bracers, and at least two flow conveyors

2. Liquid conduit of claim 1 wherein degasification apparatus comprises means to reduce turbulent flow

3. Liquid conduit of claim 2 wherein degasification apparatus reduces turbulent flow via flow conveyors establishing a more orderly flow regime as such resulting in liquid having lower levels of turbulent flow, and typically lower levels of gas composition

4. Liquid conduit of claim 2 wherein degasification apparatus comprises means to reduce turbulent flow via flow bracers contacting liquid flow and establishing a more laminar flow as such reducing turbulence, and typically reducing gas composition of liquid

5. Liquid conduit of claim 1 wherein degasification apparatus comprises means to aerate liquid

6. Liquid conduit of claim 5 wherein degasification apparatus aerates liquid via flow conveyors applying a temporary deceleration of liquid flow thus increasing the amount of air that liquid is exposed to and as such resulting in air replacing and/or reducing the gas composition of liquid

7. Liquid conduit of claim 1 wherein degasification apparatus comprises means to increase liquid flow rate

8. Liquid conduit of claim 7 wherein degasification apparatus increases liquid flow rate via flow conveyors temporarily constricting liquid flow as such with liquid flow accelerating upon moving through and past said constriction

9. Liquid conduit of claim 1 wherein degasification apparatus comprises a plurality of flow directors

10. Liquid conduit of claim 1 wherein degasification apparatus comprises one flow bracer

11. Liquid conduit of claim 1 wherein flow bracers comprise means to hold flow director in a stable position and reduce turbulent flow of liquid

12. Liquid conduit of claim 1 wherein flow bracers comprise an airfoil shape

13. Liquid conduit of claim 1 wherein flow director does not require flow bracers to maintain a stable position due to flow director being securely affixed directly to inner surfaces of liquid conduit as such forming flow conveyors and subdividing the liquid conduit

14. Liquid conduit of claim 1 wherein flow director comprises at least one angled end with means to minimize turbulence creation upon coming into contact with liquid flow

15. Liquid conduit of claim 1 wherein degasification apparatus comprises no flow bracers

16. Liquid conduit of claim 1 wherein degasification apparatus comprises one flow conveyor

17. Liquid conduit of claim 1 wherein degasification apparatus comprises no flow conveyors

18. Liquid conduit of claim 1 wherein degasification apparatus comprises at least two flow directors

19. Liquid conduit of claim 1 wherein degasification apparatus comprises no flow director

20. Liquid conduit of claim 1 wherein degasification apparatus is removably secured within liquid conduit via adjoining with interlocking mechanism that is connected with surface of liquid conduit

21. Liquid conduit of claim 1 wherein degasification apparatus is removably secured within liquid conduit via friction

22. Liquid conduit of claim 1 wherein degasification apparatus is removably secured within liquid conduit via welding technique

23. Liquid conduit of claim 1 wherein there is more than one degasification apparatus

24. Liquid conduit of claim 1 wherein degasification apparatus is integrated with liquid conduit

25. A liquid conduit comprising: a body resembling a hollow cylinder and means to convey liquid; a degasification apparatus immovably but removably secured within path of liquid flow and comprising a perimeter body, one surface area inwardly extending from perimeter body towards cross-sectional area of liquid conduit, and at least two openings perforating said surface area

26. Liquid conduit of claim 25 wherein degasification apparatus comprises means to aerate liquid

27. Liquid conduit of claim 26 wherein degasification apparatus aerates liquid via liquid flow contacting surface area and being directed through openings as such with gas composition of liquid being replaced by adjacent air

28. Liquid conduit of claim 25 wherein degasification apparatus comprises means to degas liquid

29. Liquid conduit of claim 28 wherein degasification apparatus degasses liquid via liquid flow contacting surface area and being directed through openings as such with gas composition of liquid being physically released from liquid

30. Liquid conduit of claim 28 wherein degasification apparatus degasses liquid via causing liquid flow to have a generally intersecting movement as it moves downstream as such with gas composition of liquid being physically released from liquid

31. Degasification apparatus of claim 25 wherein degasification apparatus comprises a body that is synchronized with circumference, shaping, and functionality of liquid conduit as such not necessarily being a perimeter body

32. Liquid conduit of claim 25 wherein degasification apparatus comprises at least two surface areas

33. Degasification apparatus of claim 32 wherein openings are adjacent to the surface areas

34. Degasification apparatus of claim 32 wherein openings are adjacent to surface areas and perforate surface areas

35. Liquid conduit of claim 25 wherein degasification apparatus comprises one opening

36. Liquid conduit of claim 25 wherein degasification apparatus is removably secured within liquid conduit via adjoining with interlocking mechanism that is connected with surface of liquid conduit

37. Liquid conduit of claim 25 wherein degasification apparatus is removably secured within liquid conduit via friction

38. Liquid conduit of claim 25 wherein degasification apparatus is removably secured within liquid conduit via welding technique

39. Liquid conduit of claim 25 wherein degasification apparatus is integrated with liquid conduit

40. Liquid conduit of claim 25 wherein there is more than one degasification apparatus

41. A liquid conduit comprising: a body resembling a hollow cylinder and means to convey liquid; a degasification apparatus immovably but removably secured within path of liquid flow and comprising components of degasification apparatus of claim 1 adjoined with components of degasification apparatus of claim 25

42. Liquid conduit of claim 41 wherein components of degasification apparatus of claim 1 is positioned upstream from components of degasification apparatus of claim 25

43. Liquid conduit of claim 41 wherein components of degasification apparatus of claim 1 is positioned downstream from components of degasification apparatus of claim 25

44. Liquid conduit of claim 41 wherein components of degasification apparatus of claim 1 is positioned upstream and downstream from components of degasification apparatus of claim 25
